(19) United States
(12) Patent Application Publication
(10) Pub. No.: US 2026/0251192 A1
(43) Pub. Date: Aug. 27, 2026

(54) BAND SPRING AND BRAKE PAD ASSEMBLY, BRAKE CALIPER, BRAKE PAD

(71) Applicant: Brembo S.p.A., Curno (IT)

(72) Inventors: Cristian CRIPPA, Curno (IT); Fabio SCOTTI, Curno (IT); Alberto PENDESINI, Curno (IT)

(21) Appl. No.: 18/877,002

(22) PCT Filed: Jun. 29, 2023
(86) PCT No.: PCT/IB2023/056742

§ 371 Date: Dec. 19, 2024

(30) Foreign Application Priority Data
Jul. 1, 2022 (IT) 102022000014017

(51) Int. Cl. F16D 65/097; F16D 55/00; F16D 55/224; F16D 55/228; F16D 65/00; F16D 127/02

(52) U.S. Cl. CPC F16D 65/0973; F16D 55/224; F16D 55/228; F16D 65/0075; F16D 2055/002; F16D 2127/02

(57) ABSTRACT

The present invention relates to a band spring and brake pad assembly (1) for a brake caliper (5), comprising—a brake pad (5) comprising a plate (10) and a friction material (11) supported by the plate (10), wherein the plate (10) comprises a first tangentially outer edge (14) and a second tangentially outer edge (15), which are diametrically opposite or specular with respect to a centerline plane (A-R), wherein said centerline plane (A-R) is parallel to said axial direction (A-A) and said radial direction (R-R), wherein the plate (10) comprises a radially outer edge (16) and a radially inner edge (17),—a band spring (2) comprising a coupling portion (8) configured to connect to a caliper body (7), at least one spring thrust portion (9) configured to contact said brake pad (5) at said thrust portion (12) to apply an elastic bias on said brake pad (5) to move it away from the brake disc (3), wherein said thrust portion (12) is delimited at least by a ramp (18), wherein the ramp (18) is inclined at least with respect to the axial direction (A-A) and said radial direction (R-R), wherein said ramp (18) faces the same side as the friction material (11), wherein said ramp (18) extends radially and axially away from said friction material (11) between a radially inner edge (19) and a radially outer edge (20), wherein said radially outer edge (20) extends at least in the radial direction (R-R) and at least in the tangential direction (C-C) crossing said centerline plane (A-R), wherein said radially outer edge (20) comprises at least a first convex portion (21), wherein said first convex portion (21) forms a first concavity facing radially inwards (R-I), wherein said first convex portion (21) comprises a first central part (22), a first side part (23), and a second side part (24), wherein the first central part (22) is interposed between the first side part (23) and the second side part (24), wherein the band spring (2) is adapted to apply, with said spring thrust portion (9), said elastic bias at least partially on the first central part (22) of said first convex portion (21), biasing said brake pad (5) at least away from said brake disc (3) in the axial direction (A-A) and the radial direction (R-R), avoiding the contact with the first side part (23) and the second side part (24) of said first convex portion (21).

### FIELD OF THE INVENTION

The present invention relates to a band spring and brake pad assembly, as well as a brake caliper and a brake pad.

### BACKGROUND ART

In a disc brake, the brake caliper is generally arranged straddling the external peripheral margin of a brake disc, adapted to rotate about a rotation axis (X-X) defining an axial direction (A-A). In a brake disc, there are also defined a radial direction (R-R) substantially orthogonal to said axial direction (A-A), and a tangential direction (C-C) orthogonal to both said axial direction (A-A) and said radial direction (R-R), as well as a circumferential direction (T-T) locally, or rather punctually, i.e., in an intersection point of an axial and radial direction, orthogonal to both said axial direction (A-A) and said a radial direction (R-R).

As known, disc brake discs comprise a bell adapted to associate the disc with a hub of a vehicle, from which an annular portion, referred to as a braking band, extends, which is intended to cooperate with brake pads of a caliper.

Disc brake springs are known, consisting of a central portion and two end portions, where the end portions rest against the pads to elastically bias the pads away from each other to ensure a separation of the pads from the brake disc after each braking action. According to a known type of such springs, the central portion of the springs is fixed to the caliper keeping the spring in its operating position. Such known springs are used to achieve a reduction of the pad vibration; a separation of the pads from the brake disc to reduce or eliminate a residual braking torque (residual torque) due to undesired contacts between pads and brake disc, with the brake being deactivated; as well as an even wear of the pad friction linings.

In particular, the springs of the prior art generally comprise one or more connection legs, formed at the central portion of the spring, adapted to connect the springs to the caliper at coupling portions formed on the caliper.

For example, springs which connect to the caliper body so as to be placed straddling the brake disc in two tangentially opposite portions so as to bias the brake pad at two opposite side portions thereof are known. This type of spring is known from documents WO2019/243958 and WO2020/128710, where at least two springs are used, which are connected and interposed by elastic interference with a first side bridge of the caliper body and at least one central bridge of the caliper body, respectively, and with a second side bridge of the caliper body and the at least one central bridge of the caliper body. Such springs contact a radially outer edge of the pad plate at respective side ears of the brake pad. While being satisfactory, such solutions are cumbersome, involving the use of two springs working on diametrically opposite ears of the pad.

Therefore, a need is felt in the industry to provide spring and pad solutions, which allow reducing the weight and size thereof compared to the known art, thus allowing more compact and lighter caliper bodies to be made, while keeping the spring-pad interaction properties substantially unchanged, if not improving them.

Other solutions of springs and spring/pad assemblies are known, for example, from document WO201118815. Here, the use of at least one spring is disclosed, which contacts a central portion of the pad, at an upper edge or radially outer edge thereof. While being satisfactory in many respects, it has been found that the bent configuration of this spring, in combination with the contact portion of the pad, generates high friction which reduces the efficiency of detachment of the pad from the brake disc, and thus affects the decrease and/or elimination of residual torque.

Therefore, a need is felt in the industry to manufacture brake springs and pads which allow reducing the dimensions thereof, making more compact caliper bodies, without affecting the resulting deformation of the caliper body, allowing a safe and reliable positioning of the spring on the pad, and at the same time a low-friction sliding between spring and pad compared to the known art.

### Solution

The present invention aims to provide a band spring and pad assembly where a low-friction sliding is allowed between spring and pad.

This and other objects and advantages are achieved by a band spring and pad assembly according to claim 1, a brake caliper according to claim 11, and a brake pad according to claim 13.

Some advantageous embodiments are the subject of the dependent claims.

By virtue of the suggested solutions, it is possible to reduce the number of band springs utilized to elastically bias the brake pads, maintaining excellent properties of brake pad retraction from the disc by reducing, if not eliminating, any residual torque at the end of the braking action.

Additionally by virtue of the suggested solutions, the weight and size of a brake pad and a brake caliper can be reduced as compared to the known art.

Additionally by virtue of the suggested pad and band spring geometries, the assembly of the band spring to the pad can be facilitated by virtue of a self-centering coupling.

Additionally by virtue of the suggested pad and band spring geometries, it is possible to limit the contact and sliding zones of the pad and band spring to a minimum of one contact and sliding zone up to a maximum of two contact and sliding zones, allowing highly responsive retraction of the brake pad with respect to the brake disc.

### DRAWINGS

Further features and advantages of the band spring and pad assembly, brake caliper, and brake pad will be apparent from the following description of preferred embodiments thereof, given by way of non-limiting indications, with reference to the accompanying drawings, in which:

FIG. 1 is an axonometric view of a brake caliper according to a first embodiment, where a band spring and brake pad assembly according to the present invention is provided, in particular with a single band spring interacting with two opposite brake pads, where the band spring is connected to the caliper body only at two central axial tie-rods;

FIG. 2 is a top view of the brake caliper in FIG. 1;

FIG. 3 is an axonometric view of a band spring of the band spring and pad assembly according to the present invention, adapted to be used in the brake caliper in FIG. 1;

FIG. 4 is a side view of the band spring in FIG. 3, in which the shaped spring thrust portion with two U-or V-shaped branches can be seen;

FIG. 5 is a front view of a brake pad of the band spring and pad assembly according to the present invention, according to a first embodiment, where the brake pad comprises a single thrust portion adapted to slide and come into contact with the band spring according to the embodiments of the present invention, where the thrust portion is curved and has a radially outer maximum so that the spring contacts the pad only at said radially outer maximum to retract the brake pad in the absence of braking;

FIG. 6 is a partially sectioned front view of the brake caliper in FIG. 1, in which the brake pad in FIG. 5 coupled to the band spring in FIG. 3 can be seen, with four coupling arms coupled in pairs to two axial tie-rods of the caliper body;

FIG. 7 is a front view, from the rear side of the brake pad, of the band spring and pad assembly in FIG. 6, in which brake caliper thrust elements or pistons are shown;

FIGS. 8, 9, and 10 are cross-section views of the band spring and brake pad assembly, taken along section planes J-J, K-K, and H-H, so as to show that the band spring and pad are in contact in only a central part of the spring thrust end and a central part of the plate thrust portion;

FIG. 11 is a front view of a brake pad of the band spring and pad assembly according to the present invention, according to a second embodiment, where the brake pad comprises a single thrust portion adapted to slide and come into contact with the band spring according to the embodiments Of the present invention, where the thrust portion has a profile forming a dip between two convex portions, where the band spring is configured to contact the thrust portion in two diametrically opposite contact zones within the dip with two diametrically opposite spring edges;

FIG. 12 is a partially sectioned front view of the brake caliper in FIG. 1, in which the brake pad in FIG. 11 coupled to a band spring having only two coupling arms coupled to respective axial tie-rods of the caliper body can be seen;

FIG. 13 is a front view, from the rear side of the brake pad, of the band spring and pad assembly in FIG. 12, where brake caliper thrust elements or pistons are shown;

FIGS. 14, 15, and 16 are cross-section views of the band spring and brake pad assembly, taken along the section planes J-J, K-K, and H-H, so as to show that the band spring and pad are in contact in two contact zones, avoiding the band spring and pad from coming into contact with central portions of the band spring thrust end and the plate thrust portion;

FIG. 17 is a partially sectioned front view of the brake caliper in FIG. 1, in which a brake pad according to a third embodiment can be seen, where the thrust portion of the brake pad is made in the center of gravity of the pad as a through window passing through the plate and the friction material closed by four sides, where the thrust portion has the same profile as the thrust portion of the brake pad shown in FIG. 5;

FIG. 18 is a partially sectioned front view of the brake caliper in FIG. 1, in which a brake pad according to a fourth embodiment can be seen, where the thrust portion of the brake pad is made in the center of gravity of the pad as a through window passing through the plate and the friction material closed by four sides, where the thrust portion has the same profile as the thrust portion of the brake pad shown in FIG. 11;

FIG. 19 is an axonometric view of a brake caliper according to a first embodiment, where a band spring and brake pad assembly according to the present invention is provided, in particular with a single band spring interacting with two opposite brake pads, where the band spring is connected to a tangential tie-rod of the caliper body, where the band spring is made with a single spring band;

FIG. 20 is a top view of the brake caliper in FIG. 19;

FIG. 21 is an axonometric view of a band spring of the band spring and pad assembly according to the present invention, adapted to be used in the brake caliper in FIG. 19.

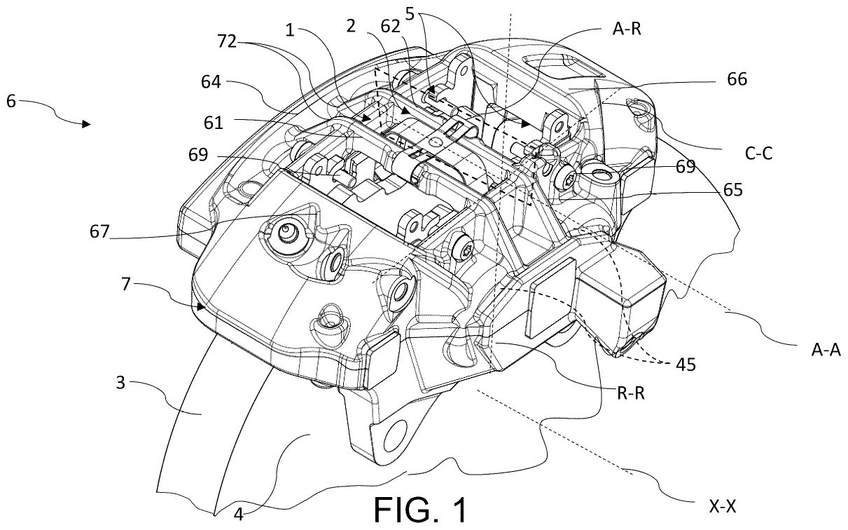

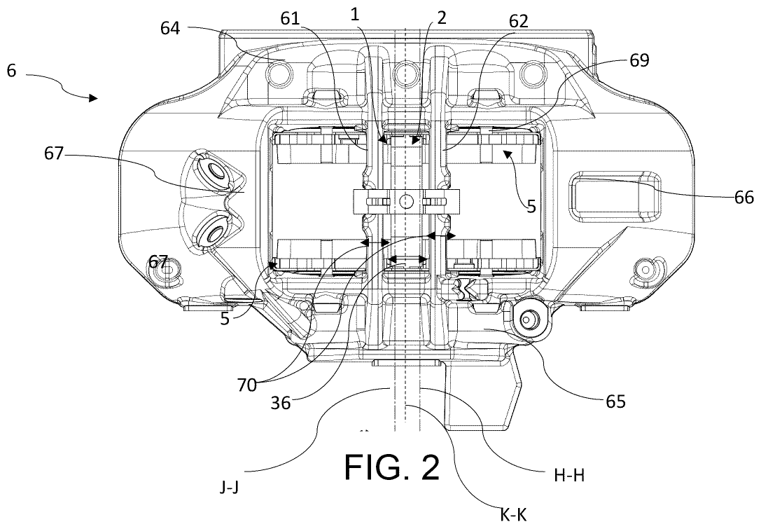

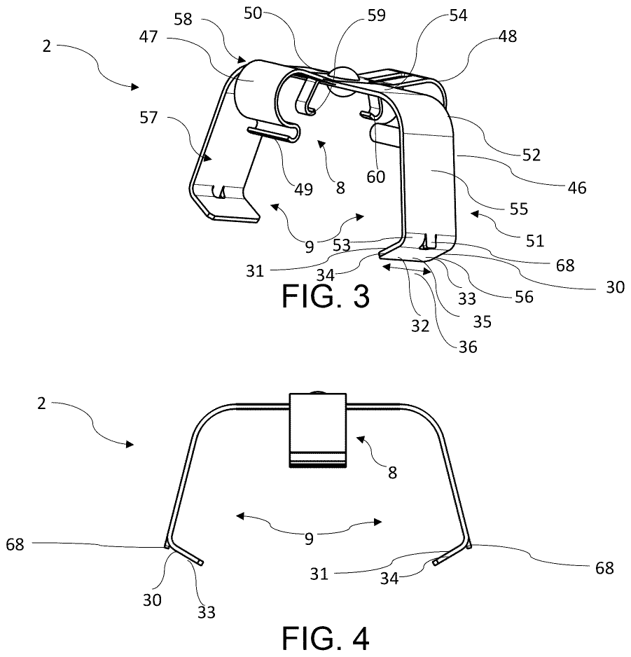

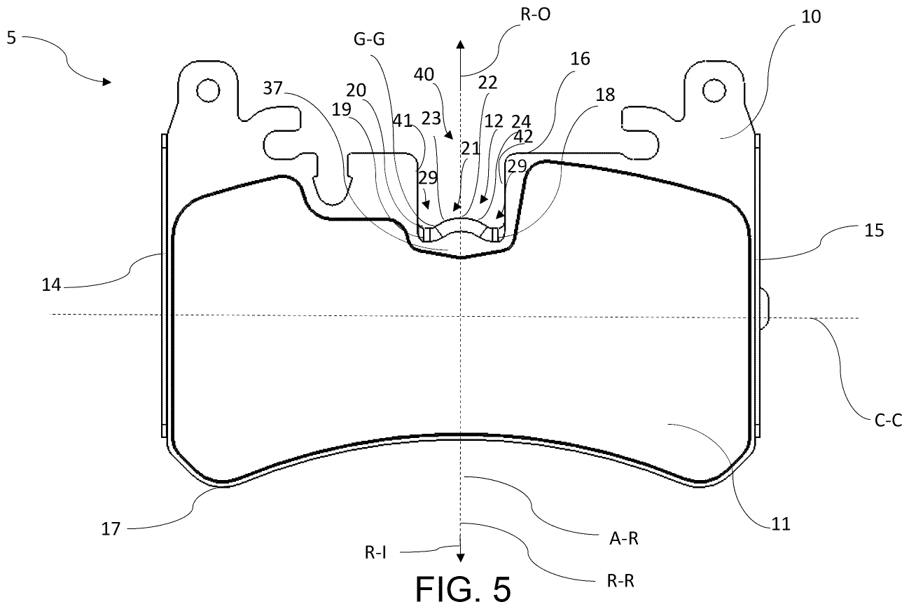

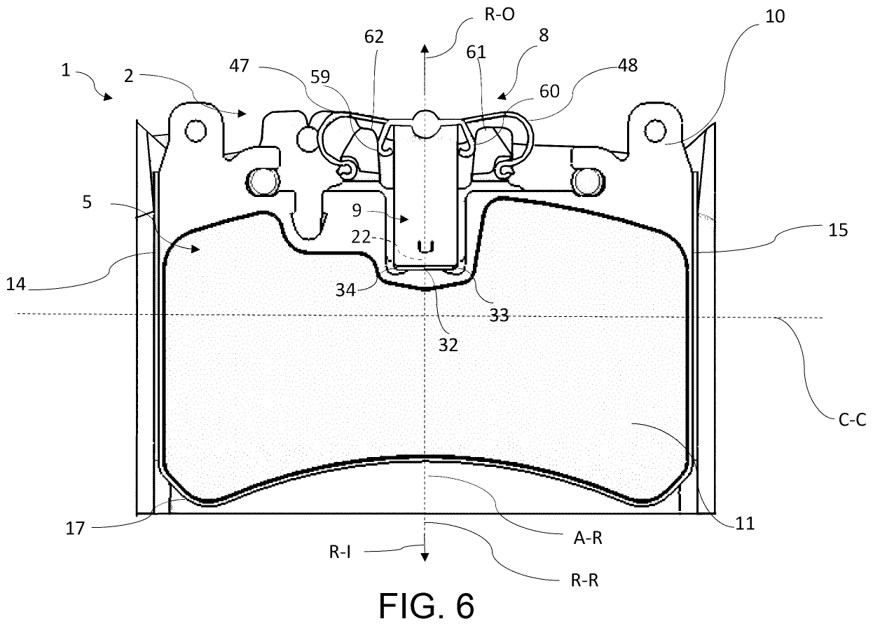

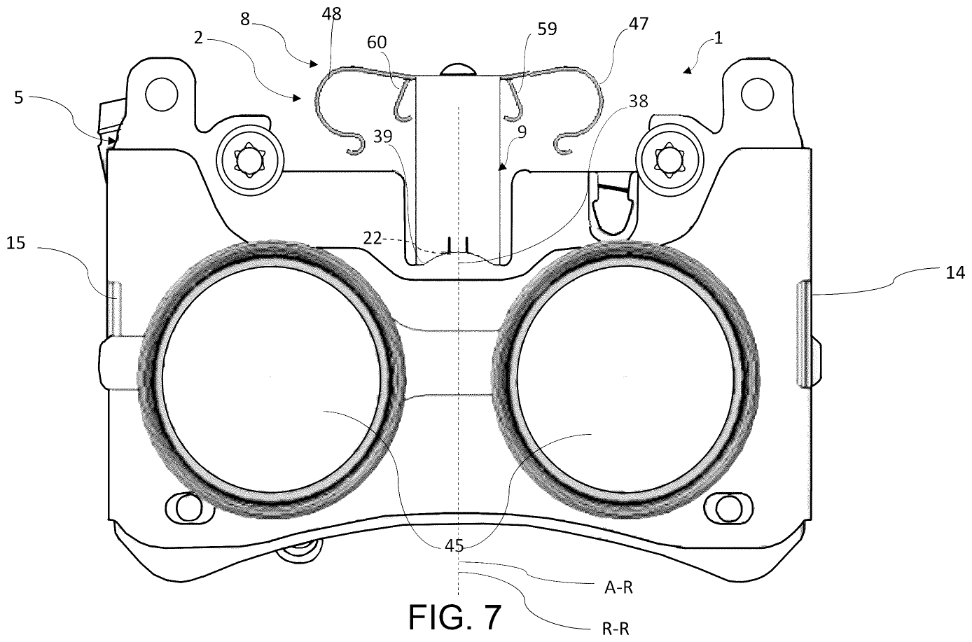

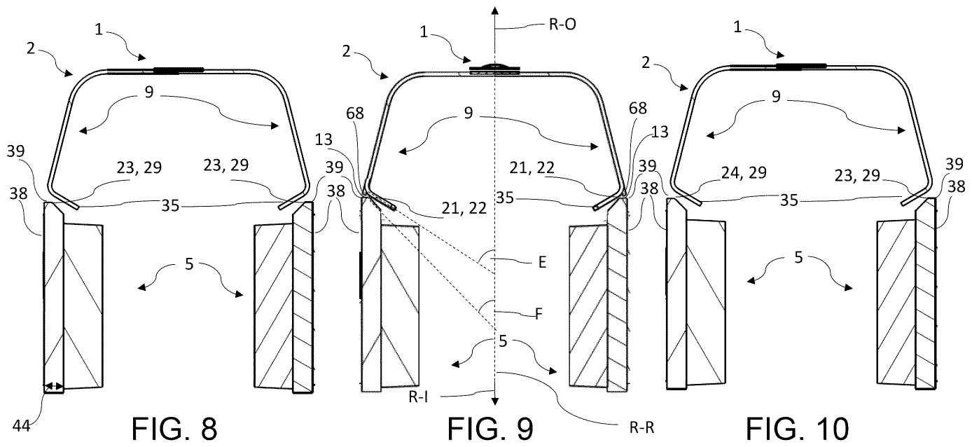

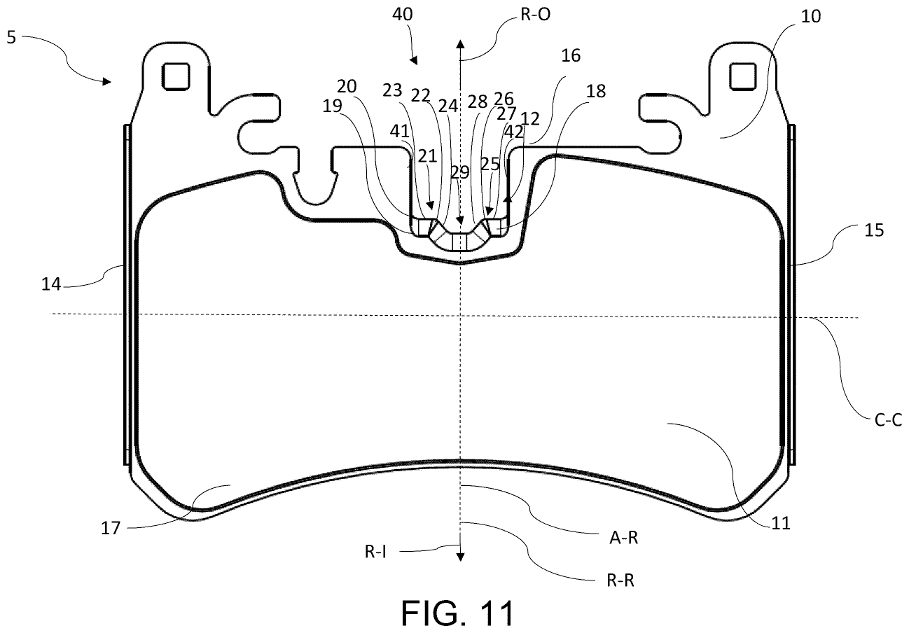

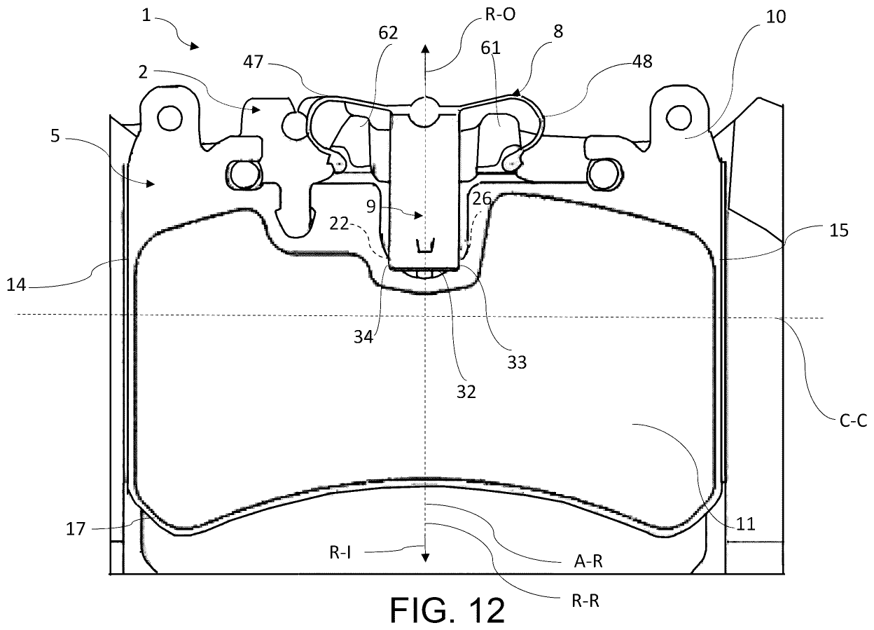

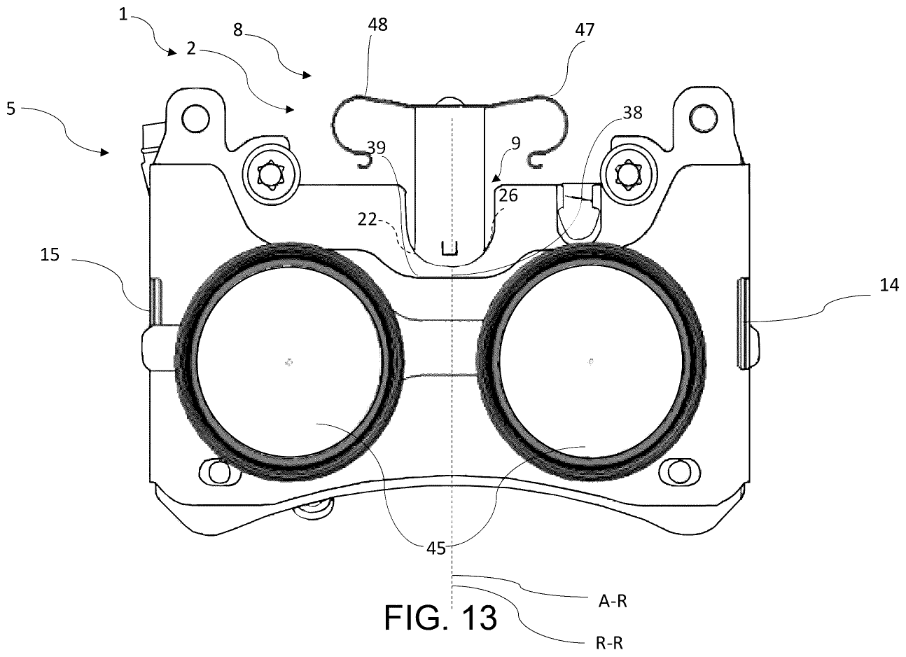

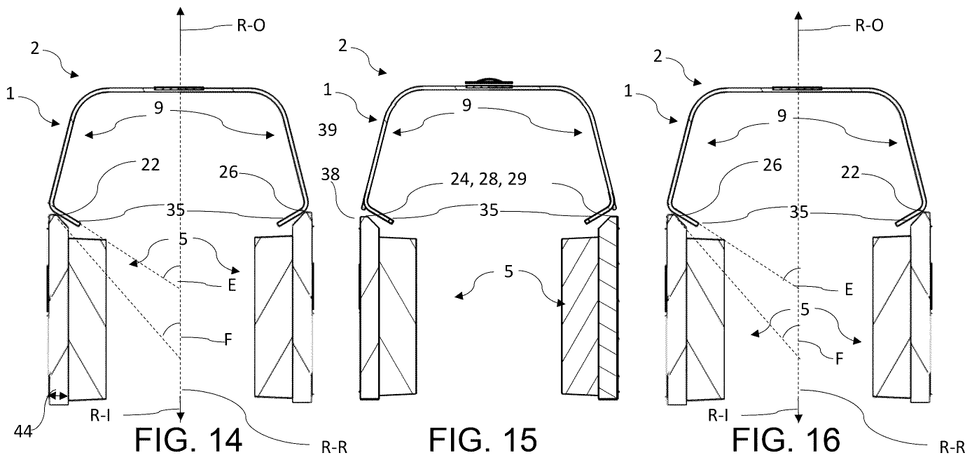

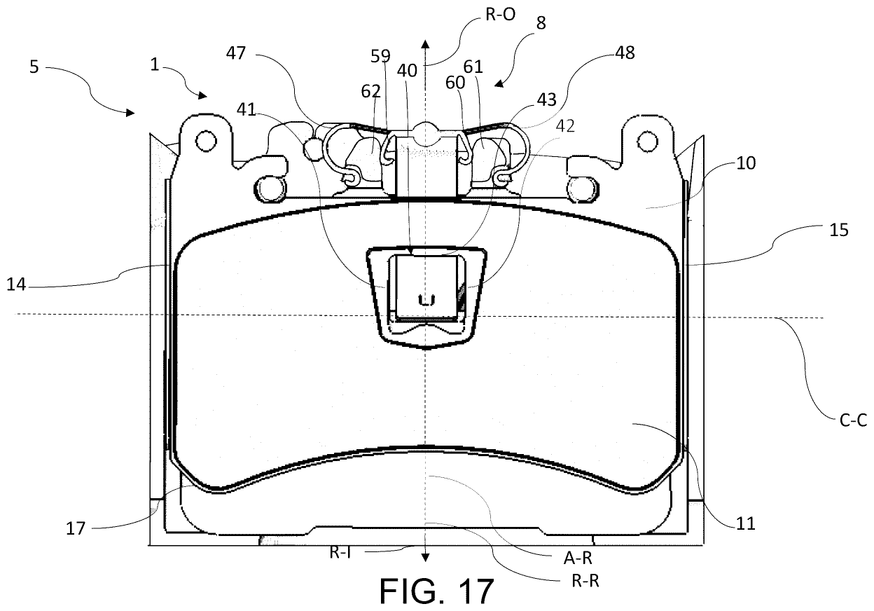

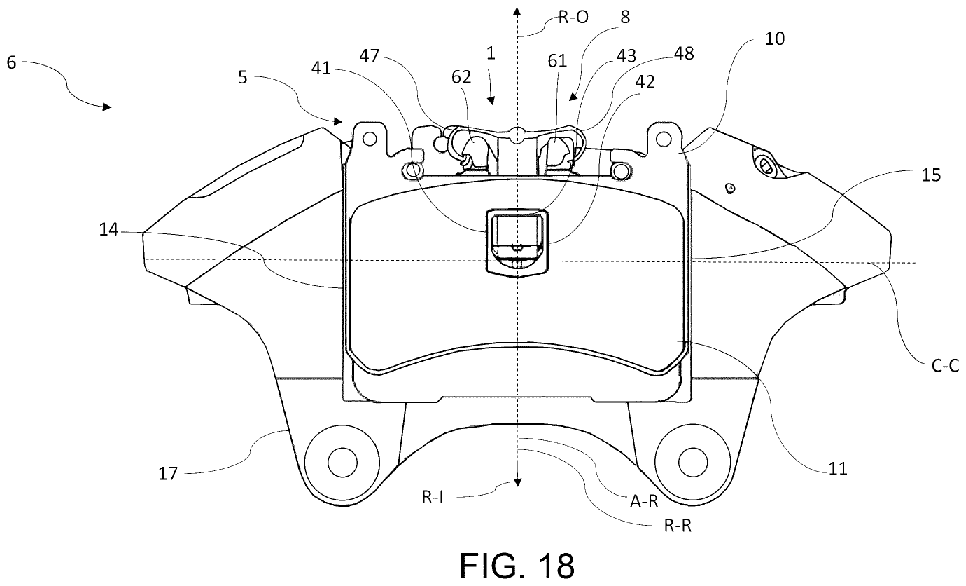

### DESCRIPTION OF SOME PREFERRED EMBODIMENTS

According to a general embodiment, a band spring and brake pad assembly for a brake caliper 6 is indicated by reference numeral 1 as a whole.

Said assembly 1 defines an axial direction A-A, a radial direction R-R perpendicular to the axial direction A-A, and a tangential direction C-C perpendicular to both said axial direction A-A and said radial direction R-R. Within the present description, where not otherwise specified, axial direction A-A, radial direction R-R, and tangential direction C-C can be understood to mean directions coinciding therewith or parallel thereto.

Said assembly 1 comprises a brake pad 5 comprising a plate 10 and a friction material 11 supported by the plate 10. The friction material 11 is adapted to contact a braking surface 4 of a brake disc 3. Said brake disc 3 has a rotation axis X-X about which it rotates, where the rotation axis X-X is parallel to the axial direction A-A.

The plate 10 comprises a first tangentially outer edge 14 and a second tangentially outer edge 15 which are diametrically opposite or specular with respect to a centerline plane A-R. Said centerline plane A-R is parallel to said axial direction A-A and said radial direction R-R. According to an embodiment, said first tangentially outer edge 14 and said second tangentially outer edge 15 extend mainly linearly in the radial direction R-R.

The plate 10 comprises a radially outer edge 16 and a radially inner edge 17. Said radially outer edge 16 faces at least partially along said radial direction R-R radially outwards R-O away from the rotation axis X-X. Said radially inner edge 17 faces at least partially along said radial direction R-R radially inwards R-I towards the rotation axis X-X. Said radially outer edge 16 comprises a thrust portion 12.

Said assembly 1 comprises a band spring 2. The band spring 2 comprises a coupling portion 8 configured to connect to a caliper body 7, at least one spring thrust portion 9 configured to contact said brake pad 5 at said thrust portion 12 to apply an elastic bias on said brake pad 5 to move it away from the brake disc 3, where the spring thrust portion 9 is connected to said coupling portion 8. According to an embodiment, a band spring 2 is shaped to be arranged straddling a brake disc 3 to apply said elastic bias onto at said least one brake pad 5 to bias it away from said brake disc 3.

Said thrust portion 12 is delimited at least by a ramp 18. The ramp 18 is inclined at least with respect to the axial direction A-A and said radial direction R-R. Said ramp 18 faces the same side as the friction material 11.

Said ramp 18 extends radially and axially away from said friction material 11 between a radially inner edge 19 and a radially outer edge 20, where said radially outer edge 20 extends at least in the radial direction R-R and at least in the tangential direction C-C crossing said centerline plane A-R.

Advantageously, said radially outer edge 20 comprises at least a first convex portion 21. Said first convex portion 21 forms a first concavity facing radially inwards R-I. Said first convex portion 21 comprises a first central part 22, a first side part 23, and a second side part 24. The first central part 22 is interposed between the first side part 23 and the second side part 24.

Advantageously, the band spring 2 is adapted to apply, with said spring thrust portion 9, said elastic bias at least partially on the first central part 22 of said first convex portion 21, biasing said brake pad 5 at least away from said brake disc 3 in the axial direction A-A, avoiding the contact with the first side part 23 and the second side part 24 of said first convex portion 21.

By virtue of the assembly 1 according to the present invention, it is possible to limit the contact zones between the band spring 2 and the brake pad 5 as much as possible so as to allow safe contact between band spring and pad, and to allow the pad to move away from the brake disc once the highly efficient braking action is finished.

According to an embodiment, said radially outer edge 20 comprises at least a second convex portion 25 forming a second concavity facing radially inwards R-I. According to an embodiment, said radially outer edge 20 comprises at least one concave portion 29 forming a third concavity facing radially outwards R-O. According to an embodiment, said concave portion 29 is central with respect to said first convex portion 21 and said second convex portion 25, which are tangentially external with respect to said concave portion 29.

According to an embodiment, said spring thrust portion 9 applies said elastic bias on said first convex portion 21 and said second convex portion 25, biasing said brake pad 5 at least away from said brake disc 3 in the axial direction A-A, avoiding the contact with said concave portion 29.

According to an embodiment, said second convex portion 25 comprises a second central part 26, a third side part 27, and a fourth side part 28, where the second central part 26 is interposed between the third side part 27 and the fourth side part 28.

According to an embodiment, the band spring 2 is adapted to apply, with said spring thrust portion 9, said elastic bias at least partially on the second central part 26 of said second convex portion 25, biasing said brake pad 5 at least away from said brake disc 3 in the axial direction A-A, avoiding the contact with the third side part 27 and the fourth side part 28 of said second convex portion 25.

According to an embodiment, said spring thrust portion 9 applies said elastic bias on said first convex portion 21 and said second convex portion 25, biasing said brake pad 5 at least away from said brake disc 3 in the axial direction A-A, only contacting said first convex portion 21 and said second convex portion 25 avoiding contacting elsewhere said brake pad 5 with said spring thrust portion 9.

By virtue of the band spring and brake pad assembly 1, it is possible to make only two contact and sliding zones between the brake pad and the band spring to allow a pad retraction once the braking action is finished.

According to an embodiment, the band spring 2 is adapted to apply, with said spring thrust portion 9, said elastic bias on the brake pad 5, biasing said brake pad 5 at least away from said brake disc 3 in the axial direction A-A, and biasing said brake pad 5 in the radial direction R-R.

According to an embodiment, said concave portion 29 is radially inner with respect to said first convex portion 21 and said second convex portion 25, where said concave portion 29 crosses said centerline plane A-R.

According to an embodiment, said radially outer edge 20 extends along a longitudinal edge direction G-G which is centrally U-shaped, at least partially inclined with respect to both said radial direction R-R and said tangential direction C-C, and laterally is linear, parallel to said tangential direction C-C.

According to an embodiment, said spring thrust portion 9 comprises a first spring edge 30 and a second spring edge 31, tangentially opposite to each other. According to an embodiment, said spring thrust portion 9 contacts said first convex portion 21 with said first spring edge 30 and said second convex portion 25 with said second spring edge 31.

According to an embodiment, said spring thrust portion 9 comprises a radially inner face 32 facing radially inwards R-I towards said brake pad 5. According to an embodiment, said radially inner face 32 extends along said tangential direction C-C between a first spring edge 33 and a second spring edge 34. According to an embodiment, said spring thrust portion 9 contacts said first convex portion 21 with said first spring edge 33 and said second convex portion 25 with said second spring edge 34. According to an embodiment, said first spring edge 33 and said second spring edge 34 are rounded.

According to an embodiment, said spring thrust portion 9 comprises a thrust end 35 configured to contact said brake pad 5, where said thrust end 35 defines a thrust portion width 36. According to an embodiment, between said second side part 24 of said first convex portion 21 and said fourth side part 28 of said second convex portion 25 there is a first tangential distance along said tangential direction C-C or a direction parallel thereto. According to an embodiment, between said first side part 23 of said first convex portion 21 and said third side part 27 of said second convex portion 25 there is a second tangential distance along said tangential direction C-C or a direction parallel thereto. According to an embodiment, said thrust portion width 36 is greater than said first tangential distance and is less than said second interference distance so that said thrust end 35 interferes with said first central part 22 and said second central part 27, self-centering with respect to said thrust portion 12. According to an embodiment, said thrust portion width 36 is equal to a central tangential distance which is along said tangential direction C-C between said first central part 22 and said second central part 27 so that said spring thrust portion 9 self-centers on said thrust portion 12.

By virtue of the contact between only two tangentially opposite zones of the spring thrust portion 9 and the brake pad thrust portion 12, it is possible to achieve a self-centering band spring on the brake pad, allowing a highly simplified assembly.

Additionally, by virtue of the contact between only two tangentially opposite zones of the spring thrust portion 9 and the brake pad thrust portion 12, it is possible to allow a planar brake pad retraction, avoiding portions of the friction material from being worn differently during the retraction of the brake pad.

According to an embodiment, the first central part 22 is radially external with respect to said first side part 23 and said second side part 24. According to an embodiment, said first central part 22 is crossed by said centerline plane A-R. According to an embodiment, said first central part 22 forms a radially outer apical portion of said radially outer edge 20. According to an embodiment, said first central part 22 is the most radially outer portion of said radially outer edge 20.

According to an embodiment, the band spring 2 is adapted to apply, with said spring thrust portion 9, said elastic bias only on the first central part 22 of said first convex portion 21, biasing said brake pad 5 at least away from said brake disc 3 in the axial direction A-A and a radial direction R-R.

According to an embodiment, said radially outer edge 20 comprises two concave portions 29 tangentially opposite with respect to said at least a first convex portion 21, where said first convex portion 21 is radially external with respect to said two concave portions 29. The band spring 2 is adapted to apply, with said spring thrust portion 9, said elastic bias on the first convex portion 21, avoiding the contact with said two concave portions 29.

According to an embodiment, said spring thrust portion 9 comprises a thrust end 35 configured to contact said brake pad 5. Said thrust end 35 defines a thrust portion width 36. Each concave portion 29 of said two concave portions 29 is substantially U-shaped. Each concave portion 29 has a radial minimum, where a concave portion distance is defined between the radial minimums of the two concave portions 29, where said thrust portion width 36 is substantially equal to said concave portion distance.

By virtue of the provision of the thrust portion 12 of the brake pad 5, which comprises a central convex portion forming a radially outer maximum of the thrust portion 12, it is possible to limit the contact between the band spring 2 and the brake pad to a single contact and sliding zone, allowing an excellent mutual contact and positioning of the band spring and pad, allowing a highly responsive movement of the pad away from the disc as soon as the braking action is finished.

According to an embodiment, said plate 10 comprises a free front surface 37 about the friction material 11. The free front surface 37 faces the same side as the friction material 10.

According to an embodiment, said plate 10 comprises a back 38 delimiting the plate 10 on the side axially opposite to the 16 friction material 11. Said back 38 is adapted to face thrust elements 45 of the brake caliper 6.

According to an embodiment, said radially inner edge 19 is defined by the intersection of said ramp 18 and said free front surface 37.

According to an embodiment, said thrust portion 12 is delimited by an axial edge 39 extending along said axial direction A-A between said ramp 18 and said back 38. According to an embodiment, said axial edge 39 extends linearly parallel to the axial direction A-A.

According to an embodiment, said radially outer edge 20 is defined by the intersection of said ramp 18 and said axial edge 39.

According to an embodiment, said spring thrust portion 9 comprises a thrust end 35 adapted to come into contact with said brake pad 5, where said thrust end 35 is bent with respect to said radial direction R-R in the opposite direction with respect to said brake pad 5 by a spring angle, and where said ramp 18 is inclined with respect to said radial direction R-R by a ramp angle, where said ramp angle is less than said spring angle so as to avoid contact between said ramp 18 and said band spring 2.

According to an embodiment, said radially inner edge 19 extends along a longitudinal direction parallel to the extension direction of the radially outer edge 20.

According to an embodiment, said plate 10 comprises a striker portion 13. According to an embodiment, said axial edge 38 forms said striker portion 13.

According to an embodiment, said band spring 2 comprises an abutment portion 68 adapted to abut against the striker portion 13 by forming a support on an area of said striker portion 13 which prevents any slippage of said spring thrust portion 9 when the band spring 2 is subjected to external actions. According to an embodiment, said abutment portion 68 is biased to bend when it abuts against said striker portion 13. According to an embodiment, said abutment portion 68 extends cantilevered from the spring body 46.

According to an embodiment, in the working condition, the abutment portion 68 never comes into contact with the striker portion 13. According to an embodiment, as the wear of the friction material progresses, the abutment portion 68 tends to move away from the striker portion 13.

According to an embodiment, said plate 10 defines a spring housing 40 adapted to accommodate said spring thrust portion 9. Said spring housing 40 passes through at least one plate thickness. Said plate 10 comprises a first side seat wall 41 and a second side seat wall 42 which are connected to said thrust portion 12 and extend from said thrust portion 12 at least in the radial direction R-R tangentially delimiting said spring housing 40 on opposite sides. According to said embodiment, said spring housing 40 is delimited by said thrust portion 12 along said radial direction R-R radially inwards R-I.

According to an embodiment, said spring housing 40 is open in the radial direction R-R radially outwards R-O.

According to an embodiment, said spring housing 40 is closed by a radially inner wall 43 facing radially inwards R-I.

According to an embodiment, said spring housing 40 is closed by a radially inner wall 43 facing radially inwards R-I, where said spring housing 40 passes through the brake pad 5 so as to arrange said thrust portion 12 close to a center of gravity of the friction material 10.

By virtue of the positioning of the thrust portion 12 of the brake pad 5 close to the center of gravity or center of thrust of the brake pad 5, it is possible to apply the elastic force of the spring in the center of the braking band of the disc, allowing a highly balanced retraction of the brake pad. Moreover, it is possible to limit the pad deformations as much as possible.

According to an embodiment, said band spring 2 comprises a spring body 46.

According to an embodiment, said coupling portion 8 comprises at least a first coupling arm 47 and a second coupling arm 48 configured to couple the band spring 2 to the caliper body 6. Each coupling arm 47, 48 extends from a central spring portion 50 to a respective coupling end 49.

According to an embodiment, said first coupling arm 47 and said second coupling arm 48 are substantially U-bent.

According to an embodiment, said band spring 2 comprises at least a first thrust arm 51 which extends from the central spring portion 50 to the spring thrust portion 9. According to an embodiment, the spring thrust portion 9 has a respective thrust end 35. According to an embodiment, said at least a first thrust arm 51 is shaped with two U- or V-bent branches.

According to an embodiment, the first thrust arm 51 comprises a first flat thrust segment 54, which mainly extends along said axial direction A-A, a second flat thrust segment 55, which is connected to said first flat thrust segment 54 by means of a first curved thrust segment 52 so that the second flat thrust segment 55 is inclined with respect to the radial direction R-R and bent towards the central spring portion 50, and a third flat thrust segment 56 connected to said second flat thrust segment 55 by means of a second curved thrust segment 53 so that the third flat thrust segment 56 is inclined with respect to the radial direction R-R and bent towards the central spring portion 50.

According to an embodiment, said abutment portion 68 extends cantilevered from said first thrust arm 51 away from said spring thrust portion 9.

According to an embodiment, said band spring body 2 is obtained from a shaped and bent blanked sheet of predetermined spring thickness, thus forming a spring band.

According to an embodiment, the coupling portion 8 and the spring thrust portion 9 are bent in orthogonal fold planes.

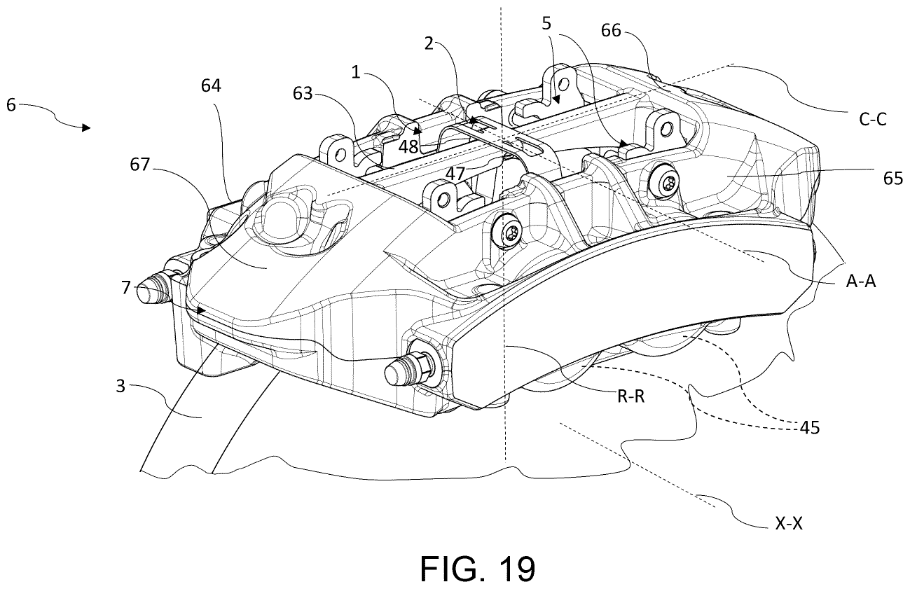

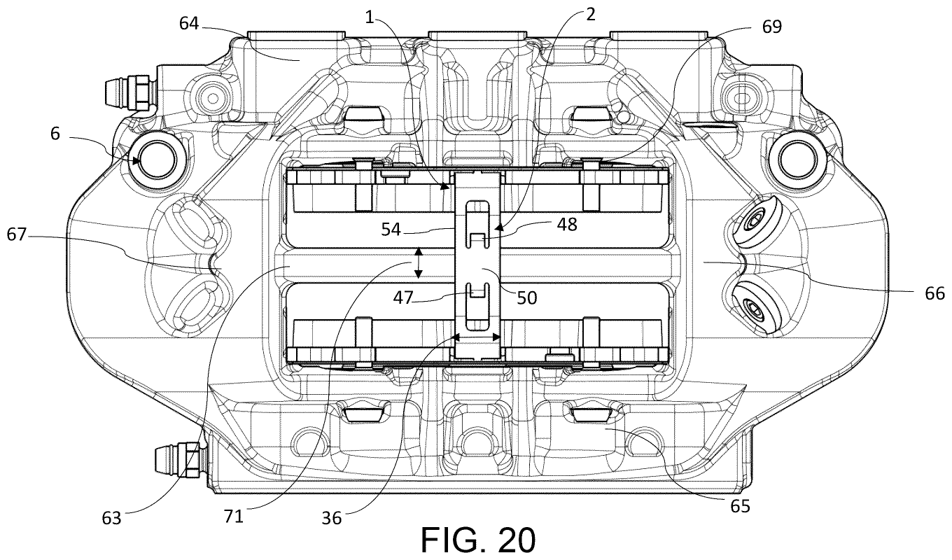

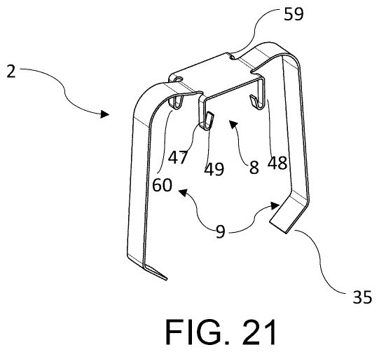

According to an embodiment, the coupling portion 8 is made in one piece with the spring thrust portion 9. For example, the coupling portion 8 is made as a tongue in the spring body 46, as shown in FIG. 21, for example, where the tongue is in a side position with respect to the thrust portion 9, or in FIG. 19, where the tongue is made in the band body of the thrust portion 9 leaving a tongue opening.

According to an embodiment, the coupling portion 8 and the spring thrust portion 9 are bent on coincident or parallel fold planes. According to an embodiment, the first coupling arm 47 and the second coupling arm 48 are configured to embrace a tangential tie-rod 63, which is parallel to the brake disc 3. According to an embodiment, the band spring comprises the first coupling arm 47 and the second coupling arm 48, without including additional coupling arms when the brake pad has the thrust portion provided with two support zones, allowing a coupling between the band spring and the self-centering pad.

According to an embodiment, said band spring 2 comprises a first spring band 57 and a second spring band 58 connected to each other at the central spring portion 50, where the first spring band 57 forms the spring thrust portion 9 and where the second spring band 58 forms the coupling portion 8.

According to an embodiment, said coupling portion 8 comprises a third coupling arm 59 and a fourth coupling arm 60. According to an embodiment, said third coupling arm 59 cooperates with said first coupling arm 47 to constrain the band spring 2 to a first axial tie-rod 61 of the caliper body 6 placed straddling the brake disc 3, and said fourth coupling arm 60 cooperates with said second coupling arm 48 to constrain the band spring 2 to a second axial tie-rod 62 of the caliper body 6 placed straddling the brake disc 3. It is thus possible to center the band spring 2 with respect to the thrust portion 12 of the brake pad, which has a single convex portion forming a radially outer maximum which allows obtaining a single contact zone between the brake pad 5 and the band spring 2.

According to an embodiment, said coupling portion 8 and said spring thrust portion 9 extend along mutually orthogonal directions. According to an embodiment, between said first axial tie-rod 61 and said second axial tie-rod 62, a tangential axial tie-rod distance is defined, where tangential axial tie-rod distance is measured with respect to a center of each axial tie-rod 61, 62 or between respective faces or edges of said axial tie-rods 61, 62 facing each other along said tangential direction C-C. According to an embodiment, the tangential axial tie-rod distance is between three times and one and a half times the thrust portion width 36 of the spring thrust portion 9. According to an embodiment, the tangential axial tie-rod distance is at a minimum equal to the thrust portion width 36.

The present invention further relates to a brake caliper indicated by reference numeral 6.

The brake caliper 6 comprises a caliper body 7 adapted to be arranged straddling a brake disc 3. Said caliper body 7 comprises a first elongated element 64, a second elongated element 65, a first connection bridge 66, and a second connection bridge 67 which connect said first elongated element 64 and said second elongated element 65 on tangentially opposite sides.

The brake caliper 6 comprises a band spring and pad assembly 1 according any one of the previously described embodiments.

Said brake pad 5 is supported either directly or indirectly by said caliper body 7 and housed in said caliper body 7.

The brake caliper 6 comprises thrust elements or pistons 45 accommodated in said first elongated element 64 and/or said second elongated element 65 to bias at least said brake pad 5 towards the brake disc 3.

According to an embodiment, said brake caliper 6 comprises a first axial tie-rod 61 and a second axial tie-rod 62 which connect said first elongated element 64 to said second elongated element 65 in the axial direction A-A, where said band spring 2 is coupled, preferably as an undercut, to said first axial tie-rod 61 and said second axial tie-rod 62, avoiding coupling to said first connection bridge 66 and/or said second connection bridge 67.

According to an embodiment, said first axial tie-rod 61 and said second axial tie-rod 62 have an axial tie-rod tangential dimension or axial tie-rod tangential thickness 70, which is less than a thrust portion width 36 of said thrust portion 9. According to an embodiment, each axial tie-rod tangential dimension or tangential thickness is measured as the distance between two tangentially opposite faces of the respective axial tie-rod 61, 62, preferably between the zones in which the two tangentially opposite faces are further apart.

According to an embodiment, said first axial tie-rod 61 and said second axial tie-rod 62 extend over said first elongated element 64 and said second elongated element 65 forming reinforcing ribs 72 in reinforcing planes parallel to said axial direction A-A and said radial direction R-R.

According to an embodiment, said brake caliper 6 comprises a tangential tie-rod 63 connecting said first connection bridge 66 to said second connection bridge 67 along said tangential direction C-C overlying said brake disc 3, where said band spring 2 is coupled to said tangential tie-rod 63, preferably as an undercut.

According to an embodiment, said tangential tie-rod 63 has an axial tangential tie rod dimension or axial tangential tie-rod thickness 71, which is less than a thrust portion width 36 of said thrust portion 9. According to an embodiment, the axial tangential tie-rod dimension or axial tangential tie-rod thickness 71 is measured as the distance between two axially opposite faces of said tangential tie-rod 63, preferably between the zones in which the two axially opposite faces are further apart.

The present invention further relates to a brake pad indicated by reference numeral 5. Said brake pad 5 defines an axial direction A-A, a radial direction R-R perpendicular to the axial direction A-A, and a tangential direction C-C perpendicular to both said axial direction A-A and said radial direction R-R.

Said brake pad 5 comprises a plate 10 and a friction material 11 supported by the plate 10, where the friction material 11 is adapted to contact a braking surface 4 of a brake disc 3, where said brake disc 3 has a rotation axis X-X about which it rotates, where the rotation axis X-X is parallel to the axial direction A-A.

The plate 10 comprises a first tangentially outer edge 14 and a second tangentially outer edge 15, which are diametrically opposite or specular with respect to a centerline plane A-R, where said centerline plane A-R is parallel to said axial direction A-A and said radial direction R-R.

The plate 10 comprises a radially outer edge 16 and a radially inner edge 17, where said radially outer edge 16 faces at least partially along said radial direction R-R radially outwards R-O away from the rotation axis X-X, where said radially inner edge 16 faces at least partially along said radial direction R-R radially inwards R-I towards the rotation axis X-X.

Said radially outer edge 16 comprises a thrust portion 12, which is adapted to be contacted by a band spring 2 to receive an elastic bias away from the brake disc 3. Said thrust portion 12 is delimited at least by a ramp 18, where the ramp 18 is inclined at least with respect to the axial direction A-A and said radial direction R-R, where said ramp 18 faces the same side as the friction material 11. Said ramp 18 extends radially and axially away from said friction material 11 between a radially inner edge 19 and a radially outer edge 20. Said radially outer edge 20 comprises at least a first convex portion 21, where said first convex portion 21 forms a first concavity facing radially inwards R-I. Said first convex portion 21 comprises a first central part 22, a first side part 23, and a second side part 24, where the first central part 22 is interposed between the first side part 23 and the second side part 24, so that the band spring 2 is adapted to apply said elastic bias at least partially on the first central part 22 of said first convex portion 21, biasing said brake pad 5 at least away from said brake disc 3 in the axial direction A-A, while avoiding the contact with the first side part 23 and the second side part 24 of said first convex portion 21.

According to an embodiment, said brake pad 5 is the brake pad of said band spring and pad assembly 1, described above.

### LIST OF REFERENCE SIGNS

1 Band spring and brake pad assembly
2 band spring
3 brake disc
4 braking surface
5 brake pad
6 brake caliper
7 caliper body
8 coupling portion
9 flexible thrust portion
10 plate
11 friction material
12 thrust portion
13 striker portion
14 first tangentially outer edge
15 second tangentially outer edge
16 radially outer edge
17 radially inner edge
18 ramp
19 radially inner edge
20 radially outer edge
21 first convex portion
22 first central part
23 first side part
24 second side part
25 second convex portion
26 second central part
27 third side part
28 fourth side part
29 concave portion
30 first spring edge
31 second spring edge
32 radially inner face
33 first spring edge or first radially inner thrust portion edge
34 second spring edge or second radially inner thrust portion edge
35 thrust end
36 thrust portion width
37 free front plate surface
38 plate back
39 axial edge
40 spring housing
41 first side seat wall
42 second side seat wall
43 radially inner wall
44 plate thickness
45 thrust elements or pistons
46 spring body
47 first coupling arm
48 second coupling arm
49 coupling ends
50 central spring portion
51 first thrust arm
52 first curved thrust segment
53 second curved thrust segment
54 first flat thrust segment
55 second flat thrust segment
56 third flat thrust segment
57 first spring body band
58 second spring body band
59 third coupling arm
60 fourth coupling arm
61 first axial tie-rod
62 second axial tie-rod
63 tangential tie-rod
64 first elongated element
65 second elongated element
66 first connection bridge
67 second connection bridge
68 abutment portion
69 pad supporting and sliding pins
X-X rotation axis
A-A axial direction
R-R radial direction
C-C tangential direction
T-T circumferential direction
A-R centerline plane
R-I radially inwards
R-O radially outwards
G-G longitudinal edge direction
E spring angle
F ramp angle

1-13. (canceled)

14. A band spring and brake pad assembly (1) for a brake caliper (6), wherein said assembly (1) defines an axial direction (A-A), a radial direction (R-R) perpendicular to the axial direction (A-A), and a tangential direction (C-C) perpendicular to both said axial direction (A-A), and said radial direction (R-R),
wherein said assembly (1) comprises:
a brake pad (5) comprising a plate (10) and a friction material (11) supported by the plate (10), wherein the friction material (11) is adapted to contact a braking surface (4) of a brake disc (3), wherein said brake disc (3) has a rotation axis (X-X) about which it rotates, wherein the rotation axis (X-X) is parallel to the axial direction (A-A), wherein the plate (10) comprises a first tangentially outer edge (14) and a second tangentially outer edge (15), which are diametrically opposite or specular relative to a centerline plane (A-R), wherein said centerline plane (A-R) is parallel to said axial direction (A-A) and said radial direction (R-R),
wherein the plate (10) comprises a radially outer edge (16) and a radially inner edge (17), wherein said radially outer edge (16) faces at least partially along said radial direction (R-R) radially outwards (R-O) away from the rotation axis (X-X), wherein said radially inner edge (17) faces at least partially along said radial direction (R-R) radially inwards (R-I) towards the rotation axis (X-X),
wherein said radially outer edge (16) comprises a thrust portion (12),
wherein said assembly (1) comprises:
a band spring (2) comprising a coupling portion (8) configured to connect to a caliper body (7), at least one spring thrust portion (9) configured to contact said brake pad (5) at said thrust portion (12) to apply an elastic bias on said brake pad (5) to move it away from the brake disc (3), wherein the spring thrust portion (9) is connected to said coupling portion (8),
wherein said thrust portion (12) is delimited at least by a ramp (18), wherein the ramp (18) is inclined at least relative to the axial direction (A-A) and said radial direction (R-R), wherein said ramp (18) faces the same side as the friction material (11),
wherein said ramp (18) extends radially and axially away from said friction material (11) between a radially inner edge (19) to a radially outer edge (20),
wherein said radially outer edge (20) extends at least in the radial direction (R-R) and at least in the tangential direction (C-C) crossing said centerline plane (A-R),
wherein said radially outer edge (20) comprises at least a first convex portion (21),
wherein said first convex portion (21) forms a first concavity facing radially inwards (R-I),
wherein said first convex portion (21) comprises a first central part (22), a first side part (23) and a second side part (24), wherein the first central part (22) is interposed between the first side part (23) and the second side part (24),
wherein the band spring (2) is adapted to apply, with said spring thrust portion (9), said elastic bias at least partially on the first central part (22) of said first convex portion (21), biasing said brake pad (5) at least away from said brake disc (3) in the axial direction (A-A), avoiding contacting the first side part (23) and the second side part (24) of said first convex portion (21).

15. A band spring and brake pad assembly (1) according to claim 14, wherein said radially outer edge (20) comprises at least a second convex portion (25), which forms a second concavity facing radially inwards (R-I),
wherein said radially outer edge (20) comprises at least one concave portion (29), which forms a third concavity facing radially outwards (R-O),
wherein said concave portion (29) is central to said first convex portion (21) and said second convex portion (25),
wherein said spring thrust portion (9) applies said elastic bias on said first convex portion (21) and on said second convex portion (25), biasing said brake pad (5) at least away from said brake disc (3) in the axial direction (A-A), avoiding contacting said concave portion (29).

16. A band spring and brake pad assembly (1) according to claim 14, comprising at least one of the following:
wherein said second convex portion (25) comprises a second central part (26), a third side part (27), and a fourth side part (28), wherein the second central part (26) is interposed between the third side part (27) and the fourth side part (28),
wherein the band spring (2) is adapted to apply, with said spring thrust portion (9), said elastic bias at least partially on the second central part (26) of said second convex portion (25), biasing said brake pad (5) at least away from said brake disc (4) in the axial direction (A-A), while avoiding contacting the third side part (27) and the fourth side part (28) of said second convex portion (25),
and/or wherein said spring thrust portion (9) applies said elastic bias on said first convex portion (21) and on said second convex portion (25), biasing said brake pad (5) at least away from said brake disc (3) in the axial direction (A-A) and radial direction (R-R), contacting exclusively said first convex portion (21) and said second convex portion (25) avoiding contacting elsewhere said brake pad (5) with said spring thrust portion (9), and/or wherein said concave portion (29) is radially inner relative to said first convex portion (21) and said second convex portion (25), wherein said concave portion (29) crosses said centerline plane (A-R).

17. A band spring and brake pad assembly (1) according to claim 14, comprising one or more of the following features:
wherein said spring thrust portion (9) comprises a first spring edge (30) and a second spring edge (31), tangentially opposite to each other, wherein said spring thrust portion (9) contacts said first convex portion (21) with said first spring edge (30) and said second convex portion (25) with said second spring edge (31),
and/or wherein said spring thrust portion (9) comprises a radially inner face (32) facing radially inwards (R-I) towards said brake pad (5),
wherein said radially inner face (32) extends along said tangential direction (C-C) between a first spring edge (33) and a second spring edge (34),
wherein said spring thrust portion (9) contacts said first convex portion (21) with said first spring edge (33) and said second convex portion (25) with said second spring edge (34),
and/or wherein said spring thrust portion (9) comprises a thrust end (35) configured to contact said brake pad (5), wherein said thrust end (35) defines a thrust portion width (36),
wherein between said second side part (24) of said first convex portion (21) and said fourth side part (28) of said second convex portion (25) there is a first tangential distance along said tangential direction (C-C) or a direction parallel thereto,
wherein between said first side part (23) of said first convex portion (21) and said third side part (27) of said second convex portion (25) there is a second tangential distance along said tangential direction (C-C) or a direction parallel thereto,
wherein said thrust portion width (36) is greater than said first tangential distance and is less than said second interference distance so that said thrust end (35) interferes with said first central part (22) and with said second central portion (27), self-centering relative to said thrust portion (12).

18. A band spring and brake pad assembly (1) according to claim 14, wherein the first central part (22) is radially outer relative to said first side part (23) and said second side part (24),
wherein said first central part (22) is crossed by said centerline plane (A-R),
wherein said first central part (22) forms a radially outer apical portion of said radially outer edge (20), wherein said first central part (22) is the most radially outer portion of said radially outer edge (20),
wherein the band spring (2) is adapted to apply, with said spring thrust portion (9), said elastic bias exclusively on the first central part (22) of said first convex portion (21), biasing said brake pad (5) at least away from said brake disc (3) in the axial direction (A-A).

19. A band spring and brake pad assembly (1) according to claim 14, comprising one or more of the following features:
wherein said first convex portion (21) is a curved portion of said thrust portion (12) which forms a radially outer maximum of said thrust portion (12),
and/or wherein said radially outer edge (20) comprises two concave portions (29) tangentially opposite relative to said at least a first convex portion (21), wherein said first convex portion (21) is radially outer relative to said two concave portions (29) wherein the band spring (2) is adapted to apply with said spring thrust portion (9) said elastic bias on the first convex portion (21), avoiding contacting said two concave portions (29).

20. A band spring and brake pad assembly (1) according to claim 14, wherein said plate (10) comprises a free front surface (37) about the friction material (11),
wherein the free front surface (37) faces the same side as the friction material (11),
wherein said plate (10) comprises a back (38), which delimits the plate (10) on the side axially opposite to the friction material (11), wherein said back (38) is adapted to face thrust elements (45) of the brake caliper (6),
wherein said radially inner edge (19) is defined by the intersection of said ramp (18) and said free front surface (37),
wherein said thrust portion (12) is delimited by an axial edge (39) which extends along said axial direction (A-A) between said ramp (18) and said back (38),
wherein said radially outer edge (20) is defined by the intersection of said ramp (18) with said axial edge (39),
wherein said spring thrust portion (9) comprises a thrust end (35) adapted to contact said brake pad (5), wherein said thrust end (35) is bent relative to said radial direction (R-R) in the opposite direction relative to said brake pad (5) by a spring angle (E), and
wherein said ramp (18) is inclined relative to said radial direction (R-R) by a ramp angle (F), wherein said ramp angle (F) is less than said spring angle (E) so as to prevent contact between said ramp (18) and said band spring (2).

21. A band spring and brake pad assembly (1) according to claim 14, wherein said plate (11) defines a spring housing (40) adapted to accommodate said spring thrust portion (9),
wherein said spring housing (40) passes through at least one plate thickness,
wherein said plate (11) comprises a first side seat wall (41) and a second side seat wall (42) that are connected to said thrust portion (12) and extend from said thrust portion (12) at least in the radial direction (R-R) tangentially delimiting said spring housing (40) from opposite sides,
wherein said spring housing (40) is delimited by said thrust portion (12) along said radial direction (R-R) radially inwards (R-I),
wherein said spring housing (40) is open in the radial direction (R-R) radially outwards (R-O) or is closed by a radially inner wall (43) facing radially inwards (R-I), in said spring housing (40) the brake pad (5) passes through to arrange said thrust portion (12) near a center of gravity of the friction material (10) or a thrust center of the brake pad (5).

22. A band spring and brake pad assembly (1) according to claim 14, wherein said band spring (2) comprises a spring body (46),
wherein said coupling portion (8) comprises at least a first coupling arm (47) and a second coupling arm (48) configured to engage the band spring (2) to the caliper body (6), wherein each coupling arm (47, 48) extends from a central spring portion (50) to a respective coupling end (49), wherein said first coupling arm (47) and said second coupling arm (48) are substantially U-bent,
wherein said band spring (2) comprises at least a first thrust arm (51), which extends from the central spring portion (50) to the spring thrust portion (9), wherein the spring thrust portion (9) has a respective thrust end (35).

23. A band spring and brake pad assembly (1) according to claim 14, comprising one or more of the following features:
wherein said band spring (2) is obtained from a shaped and folded blanked sheet of predetermined spring thickness forming a band spring, wherein the coupling portion (8) is made in one piece with the spring thrust portion (9), e.g., the engagement portion (8) is made as a tab in the spring body (46), wherein the coupling portion (8) and the spring thrust portion (9) are folded into coincident or parallel fold planes, wherein the first coupling arm (47) and the second coupling arm (48) are configured to embrace a tangential tie-rod (63), which is parallel to the brake disc (3), or
wherein said band spring (2) comprises a first spring band (57) and a second spring band (58) connected to each other at the central spring portion (50), wherein the first spring band (57) forms the spring thrust portion (9) and wherein the second spring band

(58) forms the coupling portion (8),
and/or wherein said coupling portion (8) comprises a third coupling arm (59) and a fourth coupling arm (60), wherein said third coupling arm (59) cooperates with said first coupling arm (47) to constrain the band spring (2) to a first axial tie-rod (61) of the caliper body (6) located astride the brake disc (3), and wherein said fourth coupling arm (60) cooperates with said second coupling arm (48) to constrain the band spring (2) to a second axial tie-rod (62) of the caliper body (6) placed to straddle the brake disc (3), wherein said coupling portion (8) and said spring thrust portion (9) extend along mutually orthogonal directions.

24. A brake caliper (6) comprising a caliper body (7) adapted to stand straddling a brake disc (3), wherein said caliper body (7) comprises a first elongated element (64), a second elongated element (65), a first connection bridge (66) and a second connection bridge (67) which connect from tangentially opposite sides said first elongated element (64) and said second elongated element (65),
at least one band spring and pad assembly (1) according to any one of the preceding claims, wherein said brake pad (5) is supported by said caliper body (7) and housed in said caliper body (7),
thrust elements or pistons (45) accommodated in said first elongated element (64) and/or in said second elongated element (65) to bias at least said brake pad (5) towards the brake disc (3).

25. A brake caliper (6) according to claim 24, comprising one or more of the following:
said brake caliper (6) comprises a first axial tie-rod (61) and said second axial tie-rod (62), which connect said first elongated element (64) to said second elongated element (65) in the axial direction (A-A), wherein said band spring (2) is engaged with said first axial tie-rod (61) and said second axial tie-rod (62), avoiding engagement with said first connection bridge (66) and/or said second connection bridge (67), or
said brake caliper (6) comprises a tangential tie-rod (63), which connects said first connection bridge (66) to said second connection bridge (67) along said tangential direction (C-C) hanging over said brake disc (3), wherein said band spring (2) is engaged with said tangential tie-rod (63);
and/or wherein said first axial tie-rod (61) and said second axial tie-rod (62) have an axial tie-rod tangential dimension or axial tie-rod tangential thickness (70), which is less than a thrust portion width (36) of said thrust portion (9), wherein said first axial tie-rod (61) and said second axial tie-rod (62) extend over said first elongated element (64) and said second elongated element (65) forming reinforcing ribs (72) in reinforcing planes parallel to said axial direction (A-A) and said radial direction (R-R), and/or wherein said tangential tie-rod (63) has a tangential tie-rod axial dimension or tangential tie-rod axial thickness (71) which is smaller than a thrust portion width (36) of said thrust portion (9),
and/or wherein the tangential distance between said first axial tie-rod (61) and said second axial tie-rod (62) is comprised between three times and one and a half times the thrust portion width (36) of the spring thrust portion (9).

26. A brake pad (5) for a brake caliper (7), wherein said brake pad (5) defines an axial direction (A-A), a radial direction (R-R) perpendicular to the axial direction (A-A), and a tangential direction (C-C), perpendicular to both said axial direction (A-A) and said radial direction (R-R),
comprising a plate (10) and a friction material (11) supported by the plate (10), wherein the friction material (11) is adapted to contact a braking surface (4) of a brake disc (3),
wherein said brake disc (3) has a rotation axis (X-X) about which it rotates, wherein the rotation axis (X-X) is parallel to the axial direction (A-A),
wherein the plate (10) comprises a first tangentially outer edge (14) and a second tangentially outer edge (15), which are diametrically opposite or specular relative to a centerline plane (A-R), wherein said centerline plane (A-R) is parallel to said axial direction (A-A) and said radial direction (R-R),
wherein the plate (10) comprises a radially outer edge (16) and a radially inner edge (17) wherein said radially outer edge (16) faces at least partially along said radial direction (R-R) radially outwards (R-O) away from the rotation axis (X-X), wherein said radially inner edge (16) faces at least partially along said radial direction (R-R) radially inwards (R-I) towards the rotation axis (X-X),
wherein said radially outer edge (16) comprises a thrust portion (12) adapted to be contacted by a band spring (2) to receive an elastic bias away from the brake disc (3),
wherein said thrust portion (12) is delimited at least by a ramp (18), wherein the ramp (18) is inclined at least relative to the axial direction (A-A) and said radial direction (R-R), wherein said ramp (18) faces the same side as the friction material (11),
wherein said ramp (18) extends radially and axially away from said friction material (11) between a radially inner edge (19) to a radially outer edge (20),
wherein said radially outer edge (20) extends at least in the radial direction (R-R) and at least in the tangential direction (C-C) crossing said centerline plane (A-R),
wherein said radially outer edge (20) comprises at least a first convex portion (21),
wherein said first convex portion (21) forms a first concavity facing radially inwards (R-I),
wherein said first convex portion (21) comprises a first central part (22), a first side part (23), and a second side part (24), wherein said first central part (22) is interposed between said first side part (23) and said second side part (24), so that the band spring (2) is adapted to apply said elastic bias at least partially on the first central part (22) of said first convex portion (21), biasing said brake pad (5) at least away from said brake disc (3) in the axial direction (A-A), while avoiding contacting the first side part (23) and the second side part (24) of said first convex portion (21).
